(19) United States
(12) Patent Application Publication
(10) Pub. No.: US 2026/0369022 A1
(43) Pub. Date: Nov. 19, 2026

(54) BOUNDING-BOX-BASED RETRIEVAL ENHANCEMENT

(71) Applicant: eBay Inc., San Jose, CA (US)

(72) Inventors: Janet J. JENQ, Bellevue, WA (US); Hongda SHEN, Metuchen, NJ (US); Jiaying GONG, Harrison, NJ (US)

(21) Appl. No.: 19/209,516

(22) Filed: May 15, 2025

(51) Int. Cl. G06V 10/25; G06T 7/62; G06V 20/70

(52) U.S. Cl. CPC G06V 10/25; G06T 7/62; G06V 20/70; G06V 2201/07

(57) ABSTRACT

Methods, systems, and computer storage media for generating image identifiers based on determined bounding boxes and querying an index based on the generated image identifiers in a computing system are described. The bounding-box-based retrieval engine accesses images comprising text or symbol data to determine bounding boxes for the text or symbol data within the image. These bounding boxes may be used in the generation of image identifiers which may be stored within an index that may be queried based on a query associated with a query text bounding box for query text data. A query comprising an image having text data may be accessed and utilized to generate a set of query bounding boxes. The query bounding boxes may be used to generate a query image identifier which is then compared against image identifiers stored in the index to find and output a query result.

### BACKGROUND

Users rely on item listing systems to organize and display products for sale, commonly used in e-commerce or inventory management. These systems enable efficient searching, sorting, and filtering of products based on various attributes like name, description, or category, ensuring accurate and streamlined product identification. There are several ways to identify products within these systems. Image recognition uses deep learning models, such as Convolutional Neural Networks (CNNs), to analyze product images and recognize visual features like shapes, colors, and logos. Barcode or QR code scanning is another method, allowing for instant product identification by reading unique codes linked to predefined data. Optical Character Recognition (OCR) is also widely used to extract text from images, such as product labels or packaging, and convert it into searchable data.

### SUMMARY

Various aspects of the technology described herein are generally directed to systems, methods, and computer storage media for, among other things, providing a bounding-box-based retrieval engine that can accurately identify images of products based on bounding boxes included within said products. Accurately identifying products from images is a challenging task, especially when these images contain spatially related visual and textual elements. Traditional methods often fall short, as they either focus solely on image recognition or text extraction independently, leading to inaccuracies and inefficiencies. OCR technology, while effective at extracting text, typically ignores the spatial properties of the text within the image. This spatial data, such as the bounding boxes of the text or image data, can provide valuable context for product identification. Without taking into account the spatial relation of the sets of data within an image of a product, important context for the image that can be utilized in storage and searching similar images is missed. This creates a need for a more integrated approach.

The present technical solution addresses these limitations by combining image processing and text recognition, incorporating the spatial properties of text within the image through the determination and utilization of bounding boxes. By using normalized bounding box coordinates and relative sizes of text regions, the technical solution discussed herein generates comprehensive embedding vectors that capture both visual and textual features. These embedding vectors, also discussed herein as image identifiers, may be stored in an index, allowing for efficient and accurate retrieval of similar products. This integrated approach enhances the accuracy and reliability of product identification, providing a more robust solution for identifying products in complex images such as trading cards.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1A illustrates an example flow for generating and storing text and bounding box data, in accordance with aspects of the technology described herein.

FIG. 1B illustrates an example embedding generation process, in accordance with aspects of the technology described herein;

FIG. 1C illustrates an example product, in accordance with aspects of the technology described herein;

FIG. 2A is a block diagram of an image processing system computing environment, in accordance with aspects of the technology described herein;

FIG. 2B is a flow diagram for generating image identifiers based on bounding boxes and utilizing said image identifiers based on a received query, in accordance with aspects of the technology described herein;

FIG. 3 provides a first exemplary method for generating and storing image identifiers based on determined text bounding boxes, in accordance with aspects of the technology described herein;

FIG. 4 provides a second exemplary method for generating image identifiers based on determined text bounding boxes and identifying a second image identifier based on the generated image identifier, in accordance with aspects of the technology described herein;

FIG. 5 provides a third exemplary method for generating and storing image identifiers based on determined text bounding boxes, in accordance with aspects of the technology described herein;

FIG. 6 provides a block diagram of an exemplary item listing system computing environment suitable for use in implementing aspects of the technology described herein;

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION

### Overview

An item listing system and platform support storing items (products or assets) in item databases and providing a search system for receiving queries and identifying search result items based on the queries. An item (e.g., physical item or digital item) refers to a product or asset that is provided for listing on an item listing platform. Search systems support identifying, for received queries, result items from item databases. Item databases can specifically be for content platform or item listing platforms such as EBAY content platform, developed by EBAY INC., of San Jose, California.

Product identification and finding ways to efficiently store that product identification is a critical task with widespread applications in item listing systems, e-commerce, inventory management, and automated retail systems. Current technologies for product identification primarily rely on image recognition or text extraction independently. Some image recognition systems utilize deep learning models, such as Convolutional Neural Networks (CNNs), to analyze visual features of products. These systems can effectively identify products based on their visual appearance but often struggle with images containing text or complex layouts. On the other hand, Optical Character Recognition (OCR) technology is employed to extract text from images, converting it into editable and searchable data. While OCR is proficient at recognizing text, it typically focuses on the text content alone, without considering the spatial properties of the text within the image. This separation of visual and textual analysis limits the accuracy and robustness of product identification systems and leads to item listing systems that are not accurately or efficiently searchable.

Current technologies may encounter problems when organizing and querying data for images that contain both visual and textual elements, such as product labels, packaging, or trading cards. Traditional methods that analyze image features or text independently fail to capture the full context of the image, leading to inaccuracies in product identification. Additionally, OCR systems often overlook the spatial relationships of text within the image, which can provide valuable information for identifying the product. There is a need for an improved method that integrates both image features and text recognition results, including the spatial properties of text, to enhance the accuracy and reliability of product identification. This integration would address the limitations of existing technologies and provide a more comprehensive solution for identifying products in complex images.

Item listing systems process incredible quantities of queries and transaction requests on a daily basis for incredible quantities of products listed on their systems. In order to efficiently store and process queries, item listing systems need quick and efficient methods for storing and querying accurate results. Conventionally, item listing systems store products based on user descriptions or metadata within images of products being uploaded. But the metadata and descriptions can only provide so much when utilized later on in future search. The question becomes how much data and how much user input should be stored and utilized for future searches. One would assume that the more data included in storage in association with an item the more accurate a future search would be. But the more data that needs to be stored per item increases the need for hardware processing resources exponentially, as there can be millions of products with millions of sets of computer and user generated descriptions or metadata tags. So, the problem comes down to what is the smallest or most specific amount of data that needs to be stored in association with these products in order for them to be efficiently and correctly queried based on user text and image queries. For example, a conventional system may receive an image of a two dimensional piece of paper that has various sets of text and images within the rectangular shape of the image. A conventional system may see the text or shape of the product and simply return products it deems are similar based on these prominent elements. But, when it comes to items such as trading cards, this would result in various different types of unrelated cards being returned as results. As such, a more comprehensive search engine—with an alternative basis for providing storage and search functionality—can improve computing operations and interfaces for item listing systems.

### Description of Technical Solution

At a high level, the bounding-box-based retrieval engine analyzes images to determine bounding boxes for text, symbol and image data of a product within the images. For example, the bounding-box-based retrieval engine may access an image of a trading card which has a number of sets of text data at various locations on the card. The bounding-box-based retrieval engine may identify the text and symbol data and use that text and symbol data to determine bounding boxes that encompass each set of text and symbol data. The coordinates of these bounding boxes may be normalized to the trading card so that they are representative of the bounding boxes in relation to the size of the trading card.

Once the bounding boxes have been determined, the bounding box data, such as XY coordinates for the corners of each bounding boxed may be transformed into an embedding for the image that may be stored as an image identifier in an item listing system, or used in to compare against a number of image identifiers previously stored in an item listing system. By incorporating the bounding box data, the bounding-box-based retrieval engine can determine similar products based on the positioning, size, shape, and context of bounding boxes of each product. This is particularly relevant on large item listing systems that include products such as trading cards.

Current solutions do not utilize bounding boxes in this manner to determine products that are similar based solely on bounding boxes or based on bounding boxes in addition to other information within the image. The present solution aims to solve this problem by determining and utilizing bounding boxes in the generation of image identifiers that take into account the import of the bounding box data when storing and querying item listing systems for similar products. The specific nature of the data utilized can reduce the amount of data needing to be stored and can result in improved search speed, effectiveness and efficiency.

Operationally, the bounding-box-based retrieval engine utilizes bounding box data as efficient to store and accurate in recall data for categorizing and querying item listing systems. There are certain products of item listing systems that share similarities that other products may not. For example, trading cards on average have a similar shape and various sets of text and symbol data transcribed on the front and backs of the trading cards. Where these sets of text and symbol data are located, how big they are, their shape, and the text or symbols included in the sets can be utilized to distinguish one type of card from another.

An easy way to utilize this type of data is by calculating bounding boxes for each set of image or text data on the cards. For example, baseball cards and basketball cards may overall look rather similar, but when you compare the bounding boxes, distinctions become evident. The same goes for trading cards for games such as Pokemon® or Magic the Gathering®. So, if a user is wanting to sell a basketball card, individuals who want to purchase that card will likely be looking for basketball cards.

Without processing and utilizing bounding box data, a user uploading an image of a basketball card in a search for other similar basketball cards may receive from the item listing systems what the item listing system sees as similar, such as baseball cards of Pokemon® cards. Without analyzing and utilizing bounding box data it would be easy for a computing system to see these different types of cards as all similar to the provided basketball card. But these would not be helpful results for a user wanting to sell or purchase specifically basketball cards.

Therefore, a solution, that support both efficient storage of product data and accurate product search results can include calculating bounding boxes for text or symbols for products such as trading cards and generate embeddings representing this information such that the embeddings can be stored in a query-able index. This would provide more accurate results to users searching for products that on the whole seem rather similar, but are well distinguished by the position and size of their respective bounding boxes. This would also provide for more efficient storage, as bounding box data is simple numerical data that can represent where text is located and these locations are very indicative of the types of cards and can be used to find what are accurate or very similar results.

By way of an illustrative example, a user may wish to sell a trading card. They can upload an image of the trading card to the item listing system which is then processed by the bounding-box-based retrieval engine. The image they upload may be the card as they hold it in their hand, or may be the card on a table. This image could also include multiple trading cards or other objects within the frame. The bounding-box-based retrieval engine analyzes the image to determine which items in the image are products with text or symbol data. This may include transmitting a request to the user requesting they select one or more of the items, also discussed as objects herein, for the bounding-box-based retrieval engine to process.

The image of the trading card may include text or symbol data within the trading card. For example, the trading card could have a list of numbers on the lower right, a name on the upper left, and a paragraph of text in the middle describing the card. The bounding-box-based retrieval engine may generate bounding boxes for each of these sets of symbol and text data such that there are a number of polygons that represent where the text and symbol data is located on the card and the various sizes and shapes of those sets of data.

Once these bounding boxes are generated, the bounding-box-based retrieval engine may generate an embedding for the trading card so that the embedding can be stored in a bounding box specific database such as a text-bounding box database or an item listing database. This allows the item listing system to utilize the bounding boxes when providing recommendations to other users or for returning query results to the user uploading the image.

The location and sizes of bounding boxes can be very helpful when looking for similar products. For example, Pokemon® cards have a specific design where their bounding boxes are laid out that are rather distinct than, for example, the bounding boxes of Magic the Gathering® Cards. Without taking into account the bounding boxes it would be easy for an item listing system to just classify all trading cards in the same category, or return Pokemon® card results to a user searching for Magic the Gathering® cards. The simplicity of bounding box data, a list of XY coordinates, can also assist in quick and efficient storage and searching.

### Example System and Resources

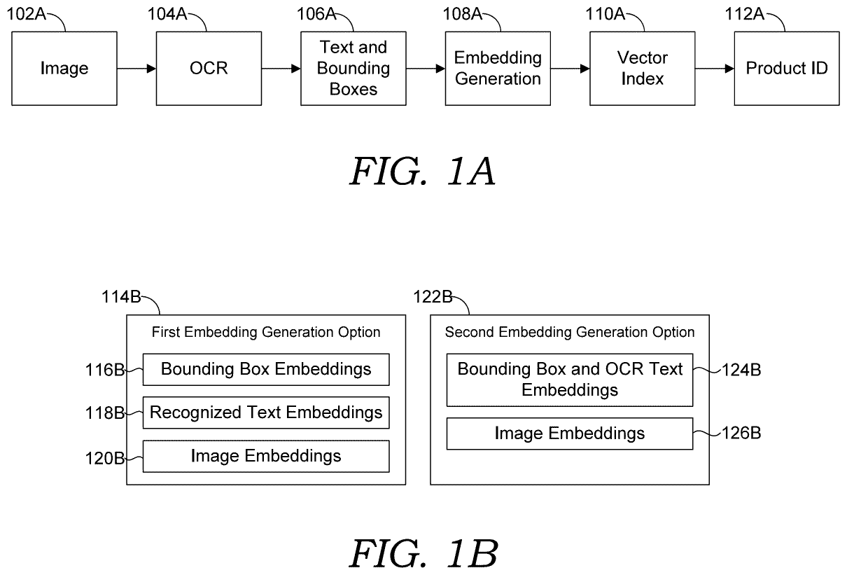

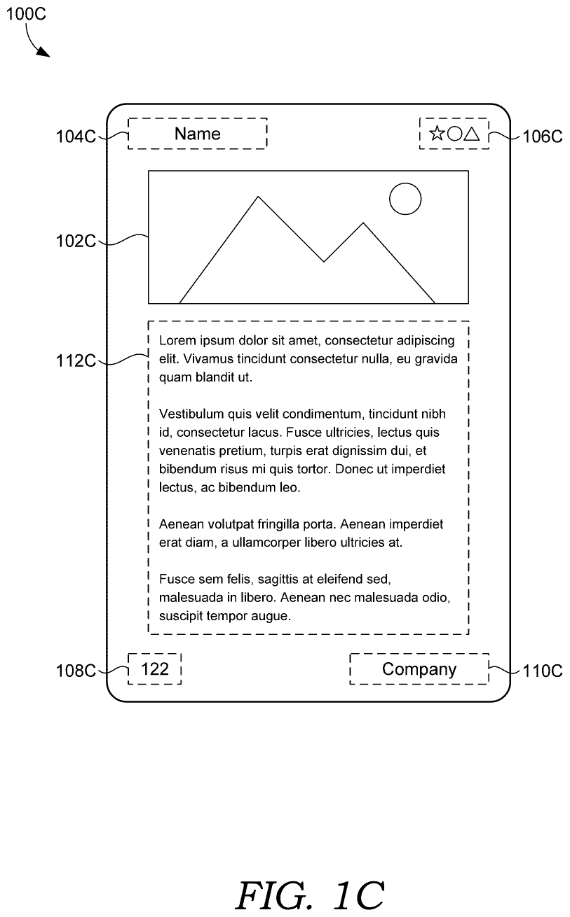

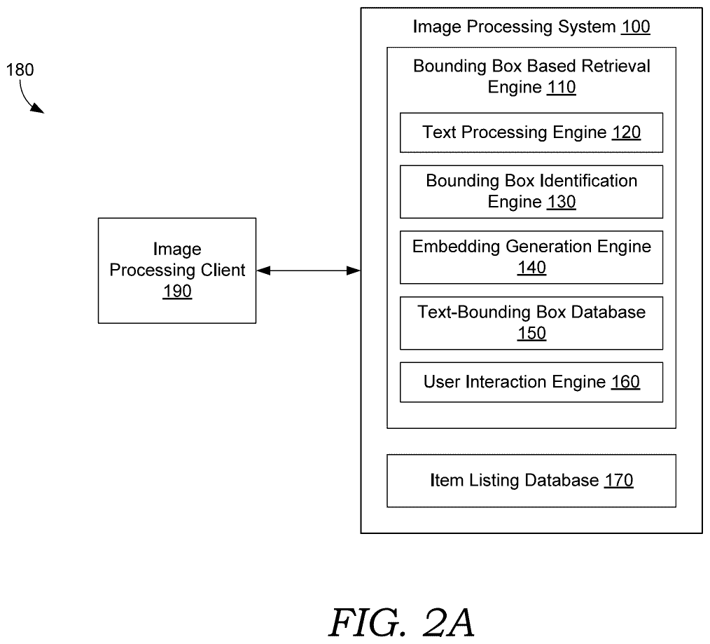

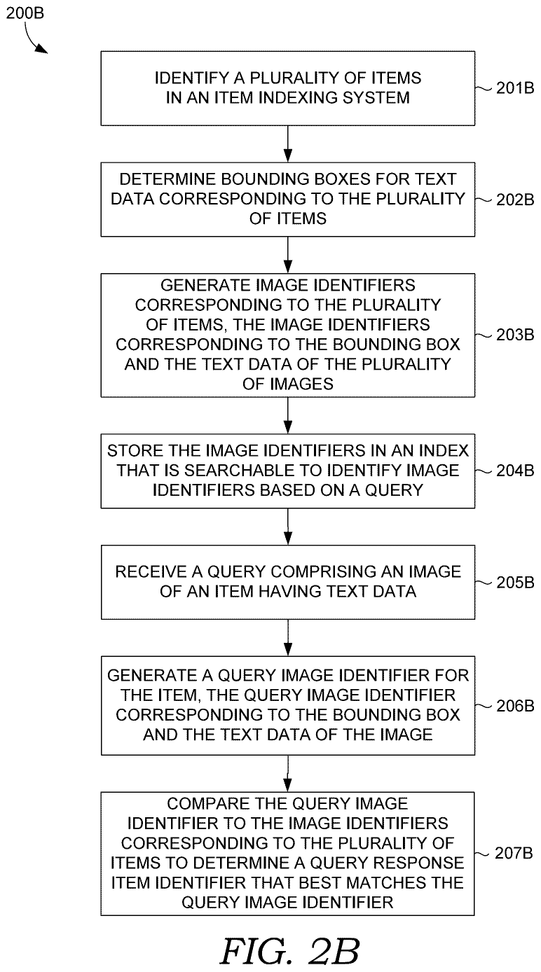

Aspects of the technical solution can be described by way of examples and with reference to FIG. 1A-1B. FIG. 1A illustrates an example flow for generating and storing text and bounding box data, in accordance with aspects of the technology described herein. In embodiments, an image may be either received or accessed. For example, the image 102A may be received as part of a query made to an item listing system. The image 102A may be already stored within a databased of an item listing system such as the item listing database 170 discussed in relation to FIG. 2A. Whether the image 102A is received as part of a query or is accessed from a database, the image may be processed to determine several things. The image may be processed for example through the use of optical character recognition (OCR 104A) to determine text within the image. For example, if the image 102A comprises a number of items or objects but only one of which comprises text data, the OCR 104A would recognize and determine the text within the image 102A wherever it appears.

In illustrative embodiments, the image 102A would comprise a trading card such as a Magic the Gathering ® card or Pokemon ®. The OCR 104A may be used to determine what text data is within the image and determine a general location of the text within the image. In the example of a trading card, the OCR 104A would determine the text within the card wherever text appears in the card. The OCR 104A could also pick up text outside of the trading card in other portions of the image 102A.

As discussed in more detail throughout, the bounding-box-based retrieval engine may be configured to determine what text to conduct OCR 104A or may conduct OCR 104A of all text within an image 102A and then conduct further processing to determine what text data to use in generating bounding boxes and generating item identifiers. As discussed above, text and bounding boxes 106A are determined for the image 102A. The bounding boxes may be generated based on determining the boundaries of each set of text data, for example, as determined by OCR 104A. A bounding box as discussed herein is a two dimensional geometric shape that surrounds the boundaries of a set of text. By way of illustration, if a set of text data on a product is three lines with 25 characters per line, the bounding box would be determined to be a shape that encompasses each of the characters in the three lines.

The bounding-box-based retrieval engine may be configured to determine the coordinates of a bounding box using any method. Bounding boxes as discussed herein may be determined using OCR 104A technology. An example process of determining bounding boxes for text within images may comprise the following steps. The image may be preprocessed to enhance text visibility. This may involve techniques like noise reduction, contrast adjustment, and binaries. OCR algorithms then scan the image to detect regions that contain text. This may be done using machine learning models trained to identify text patterns.

Once text regions are detected, bounding boxes are created around each text segment. These boxes may be rectangular and define the coordinates of the text within the image. The bounding boxes do not need to be rectangular in nature and may comprise any shape that best fits the particular set of text in a product. For example if the text is in a format that is more square or in a manner that would be better fit by a different polygon, such polygon may be used.

In embodiments, the bounding box may be a set of XY coordinates, where X corresponds to a horizontal field and Y corresponds to a vertical field. For example, if the bounding box is a rectangular polygon, the bounding box data may comprise a set of four XY coordinates for each bounding box within the product. An upper left corner XY set, an upper right corner XY set, a lower left corner XY set, and a lower right corner XY set. This set of four coordinates may be combined to represent a single bounding box and any number of bounding boxes may be detected within a product, and sets of bounding box coordinates may be determined and those coordinates may be combined for each detected bounding box.

The bounding-box-based retrieval engine may normalize the coordinates of the bounding boxes relative to the size of the image or to the product within the image. This enhances consistency across different images and products and helps in accurately comparing text positions in relation to products. For example, normalizing text boxes in an image, such as a trading card, ensures consistent positioning, scaling, and orientation of text elements. This process enhances the extraction of textual data, making it more accurate and uniform. By standardizing the appearance of text, it becomes easier to create embeddings that capture the key features of the card. These embeddings represent the card's unique attributes, such as text content and spatial relationships. As a result, they can be used to efficiently search and match similar cards in a database, improving the overall performance and accuracy of the search system.

The bounding-box-based retrieval engine may additionally or alternatively calculate the relative sizes of the bounding boxes based on their dimensions compared to the overall image size. This information may be used to understand the prominence and positioning of the text within the image. The bounding-box-based retrieval engine may extract the text within each bounding box. For example, the normalization data may be used to determine the most representative bounding box coordinates for a product that otherwise would be lost without normalization. For example, if a user takes a photograph of a trading card being held in their hand only ten inches from the camera, the bounding boxes would appear different than if the trading card was placed on a shelf or table three feet from the camera. Additional variations may occur depending on the angle the photo is taken.

As such, the bounding-box-based retrieval engine does not simply take the coordinates of a bounding box in an image and store this as bounding box data. The XY coordinates are compared against the boundaries or size of the product within the image to determine a representative set of coordinates to better reflect the bounding box relative size. This allows the bounding-box-based retrieval engine to obtain bounding box data that is representative of the particular trading card irrespective of its positioning within the image. Therefore the result of the combination of the normalization data and bounding box data may be a set of coordinates that are representative of a product that may be compared against similar products for example in a vector index 110A.

The information related to the bounding box along with the normalization data and text data may be utilized in embedding generation 108A. The embedding generation 108A step is also discussed in more detail in relation to FIG. 1B. The embedding generation 108A step may comprise generating a vector representation of various aspects of the text data, bounding box in relation to the normalization data, and the image data. The normalization data does not itself need to be stored in an embedding and instead may be used to generate a normalized bounding box data which may then be stored in the form of an embedding.

Embeddings are generated based on the bounding boxes through a process that integrates both visual and textual information from the image. Once features of the text data have been generated, the features may be transformed into embeddings such as word embeddings (e.g., Word2Vec, GloVe) or contextual embeddings (e.g., BERT) to represent the text. The bounding box coordinates and the relative sizes of the bounding boxes are normalized as discussed above, and used to generate a vector representing the normalized bounding box data for the product. In embodiments, during the embedding generation 108A step, the visual features of the image, text features of the image and the bounding box data of the image may be combined or concatenated to form a comprehensive feature vector.

In embodiments, the embedding generated in this embedding generation 108A step does not need to include all of these features. In embodiments, a bounding box embedding may be generated including only the bounding box data such as the size, shape, and location of each bounding box within the product. This may provide for increased efficiency in storage and search as the types of information helpful to find similar products may be limited to the bounding box data. In additional or alternative embodiments, the bounding box data may be concatenated or combined with the OCR text data to generate a combined text and bounding box embedding. Once the embedding has been generated, the embedding may be stored in a vector index 110A such that that the embedding may be used to search for products received via queries. The embedding does not necessarily need to be stored in the vector index 110A.

In embodiments, the above process may be used to generate an embedding, for example based on a query, and then use the generated embedding to query a vector index for a product most similar to the item requested in the query or to an image provided as part of the query. In this way, the bounding-box-based retrieval engine 110 may generate embeddings to be used in querying a vector index comprising bounding-box-based embeddings without needing to store the query embedding.

In embodiments, the generated embedding may be stored in the vector index 110A in association with a product ID 112A. As discussed in relation to FIG. 2A, the bounding-box-based identifier may be stored in a text-bounding box database 150, and the product ID 112A may be stored in an item listing database 170. In embodiments, both may be stored in either of these databases.

In additional or alternative embodiments, the text-bounding box database 150 may be included within the item listing database 170 such that embeddings that are stored within the text-bounding box database 150 are stored within the item listing database 170. The generated embeddings may be stored in association with the product ID 112A either in the vector index 110A wherein the product ID 112A is included within the embedding generated for the product. The embedding generated for the product may also be stored in association with the Product ID 112A either in the item listing database 170, text-bounding box database 150, or both such that it is not incorporated into the embedding, but is associated with the embedding.

These above described steps illustrate an embodiment in which an image may be processed to generate text data and bounding box data which may be normalized and utilized in the generation of embeddings that may be stored in a vector index in association or including a product ID. In this manner, the bounding boxes may be used to efficiently determine types of products that are similar to the product in the provided image without necessarily needing to process other visual data or other textual data within the product. The bounding-box-based retrieval engine may utilize the bounding box information to efficiently store and search an item listing database or vector index to quickly determine similar products using only the bounding box data, or utilizing the bounding box data in concert with other data extracted or generated from the image.

With reference to FIG. 1B, FIG. 1B illustrates two methods for generating embeddings. In a first embedding generation option 114B, three separate embeddings are generated, bounding box embeddings 116B, recognized text embeddings 118B, and image embeddings 120B. For each of these embeddings, raw data is transformed into numerical vectors that capture the essential features of the data. As such, the vectors created may be compared against other vectors to determine which of the other vectors are closest to the source vector.

In embodiments, three separate vectors are generated. These may each be stored in association with a product identifier, or stored in association with each other. In a second embedding generation option 122B, two embeddings are generated, for example by the bounding-box-based retrieval engine, bounding box and OCR text embeddings 124B and image embeddings 126B.

In the first embedding generation option 114B, the three embeddings are generated separately without combining or concatenating. In embodiments, the embeddings generated in the first embedding generation option 114B may be stored separately, stored in association with each other, stored in association with a product identifier, or all of the above.

In the second embedding generation option 122B, a single embedding is generated utilizing both the bounding box and OCR text data, and a separate embedding is generated with the image data. When generating the bounding box and OCR text embeddings, a bounding box vector and an OCR text vector may be generated and then combined or concatenated in order to generate bounding box and OCR text embeddings 124B. As with the first embedding generation option 114B, the bounding box and OCR text embeddings 124B may be stored separate from the image embeddings 126B, be stored in association with the image embeddings 126B, stored in association with a product identifier, or all of the above. Each of these options illustrate that a number of methods may be utilized to generate embeddings utilizing bounding box data.

With reference to FIG. 1C, FIG. 1C illustrates an example product with distinct areas within the product having text or symbol data. The text data of the upper left area 104C may be extracted or analyzed, by a text processing engine (e.g., text processing engine 120 of FIG. 2A) to determine that the text of that area displays “NAME”. Given that there is no adjacent text above, below, right or left, of the text “NAME,” this may be determined to be a set of text data. This text data would be determined to be distinct and unconnected from the text data for example in the lower middle area 112C, lower left area 108C or the lower right area 110C. As such, the text processing engine may determine where text data is located within an image and within a product of an image, what letters, characters, or words the text data represent, and which text data comprises a set of text data within the image.

A bounding box identification engine (e.g., bounding box identification engine 130 of FIG. 2A) may utilize the information extracted or determined by the text processing engine to determine bounding boxes for the various sets of text data within a product. Referring again to FIG. 1C, the dotted lines of the upper left area 104C, upper right area 106C, lower middle area 112C, lower left area 108C, and lower right area 110C illustrate example bounding boxes as determined by the bounding box identification engine.

The bounding box identification engine may utilize the sets of text data to determine coordinates that encompass a set of text data, for example the dotted lines of the upper left area 104C. The larger the text data, or the larger the amount of text data, the larger the resulting bounding box may be. Additionally the bounding box identification engine may utilize other data not necessarily retrieved by the text processing engine to generate bounding boxes. For example, the upper right area 106C of FIG. 1C comprises symbol data. As used herein, symbol data may comprise any data used to represent non-textual data within an image. For example, symbol data may be data that represents the star, circle, and triangle shape of the upper right area 106C.

The bounding box identification engine may determine that the symbols of the upper right area 106C require a bounding box and generate the same. The bounding box identification engine may also determine areas that do not require bounding boxes or may utilize instructions not to generate bounding boxes for certain sets of text or symbol data. For example, the upper middle area 102C may be determined to have text or symbol data, but the bounding box identification engine may determine not to generate a bounding box for that area.

The bounding boxes generated by the bounding box identification engine may comprise a set of coordinates such as X, Y, Z coordinates representing the corners or boundaries of a polygon, such as the rectangles of FIG. 1C, that encompass the sets of text or symbol data. The bounding box identification engine may normalize the coordinates of the bounding boxes to the product within the image. This may be accomplished by comparing the sizes of the bounding boxes to the size of the product within the image and normalizing the sizes of the bounding boxes to the size of the product within the image.

Moving to FIG. 2A, an example image processing computing environment 180 comprising an image processing client 190 and an image processing system 100 is depicted. The image processing client 190 may receive or access images either included in a database such as the item listing database 170, or from a user device. The image processing client 190 may receive interactions at a graphical user interface of a user device. For example, if a user provides an image that has more than one product within the image, the bounding-box-based retrieval engine 110 may determine what objects within the image are products and communicate a request for the user to select one or more of the products included within the image.

In embodiments, the request for selection may be communicated and processed by the user interaction engine 160. A user may also provide further clarification text or images through the image processing client 190. This may also be processed by the user interaction engine 160. For example, a user may submit a query comprising an image that has three objects. The bounding-box-based retrieval engine 110 may determine that two of the objects in the image are products, and the third object of the image is not a product.

The user interaction engine 160 may communicate a request to the image processing client 190 to display on a graphical user interface a plurality of response options of which product the user would like to search. The image processing client 190 may receive a selection of one of the response options and based on this selection, the user interaction engine 160 may determine which object or objects in the image to process and utilize in a search or to be stored within either the text-bounding box database 150 or the item listing database 170. In embodiments, the user may also indicate that the third object, not originally recognized is to be used in the search, or may indicate more than one object in the image as products to be searched.

The image processing system 100 may receive or access images or queries to generate embeddings or utilize information, such as text data, within the images to query a database of embeddings such as the text-bounding box database 150 or the item listing database 170. The bounding-box-based retrieval engine 110 may additionally or alternatively generate the embeddings and store them within the text-bounding box database 150 or the item listing database 170 such that they may be utilized in future searches.

In embodiments, the bounding-box-based retrieval engine 110 accesses images and product identifiers from the item listing database 170 and utilizes these image to generate image identifiers for these images utilizing the bounding box data as detailed herein. Once generated, these new image identifiers including the bounding box data may be stored in the text-bounding box database 150, the item listing database 170, or both.

The bounding-box-based retrieval engine 110 utilizes several engines and data sources in generating the bounding-box-based identifiers. Namely, the bounding-box-based retrieval engine 110 may utilize a text processing engine 120, a bounding box identification engine 130, an embedding generation engine 140, a text-bounding box database 150 and a user interaction engine 160 to generate the bounding-box-based identifiers.

The text processing engine 120 may analyze an image comprising text data to extract the text data from the image. An image may comprise any number of sets of text data. As used herein, a set of text data comprises text data that is within an image and has space within the image between other sets of text data.

The embedding generation engine 140 may utilize the text data as extracted or determined by the text processing engine 120 and the bounding box data as generated by the bounding box identification engine 130 to generate an image identifier or a product identifier for the image comprising the product. As used herein, an image identifier may refer to an identifier that represents the entire image including one or more products, or may refer to an identifier for a specific product within the image. The image embeddings may be generated by the embedding generation engine 140 by any known method such as transforming the text and bounding box data into vector representations of the text and bounding box data.

In embodiments a single embedding may be generated for the image data, bounding box data, and text data. In additional or alternative embodiments, separate embeddings, such as a bounding box embedding, a text embedding and an image embedding may be generated and used to generate a bounding box identifier, a text identifier and an image and stored separately on in association with one another. The bounding-box-based retrieval engine 110 may store the identifier or identifiers generated by the embedding generation engine 140 in an index that is searchable to identify identifiers based on a query associated with a query bounding box. The index may be located in the text-bounding box database 150 or the item listing database 170.

In embodiments, the bounding-box-based retrieval engine 110 may utilize all of the data generated, extracted, or determined by the text processing engine 120 bounding box identification engine 130, and embedding generation engine 140 to generate identifiers that may be used to identify products based solely on the size, shape, and location of the bounding boxes of the product. Said another way, the image identifier does not need to comprise bounding box data, text data, and other forms of data. The bounding-box-based retrieval engine 110 may generate embeddings and identifiers based solely on the bounding box coordinates as determined and normalized by the bounding box identification engine 130. By generating embeddings and identifiers based solely on bounding box data, the bounding-box-based retrieval engine 110 may minimize the amount of data needing to be stored for accurate product retrieval and may increase the speed and efficiency of searching data stores and indexes comprised of this data.

With reference to FIG. 2B, FIG. 2B, is a flow diagram for generating image identifiers based on bounding boxes and utilizing said image identifiers based on a received query by a bounding-box-based retrieval engine, in accordance with aspects of the technology described herein. The technical solution of the bounding-box-based retrieval engine can be explained by way of steps and an example of processing a request to access a secure resource.

Step 201B: identify a plurality of items in an item indexing system.

In embodiments, the items may be identified based on images stored within the item indexing system, or may be identified based on images received from a user either as part of a query or as part of a request to create a new item listing within the index. For example, a user may wish to sell a trading card, and upload an image of the trading card as they hold it in their hand. The item, meaning the trading card, may be identified within the image as part of creating the new item listing. The same process may be used when a user uploads an image as part of a query for the product in their query image or for items that are similar to the product in their image.

Step 202B: determine bounding boxes for text data corresponding to the plurality of items.

The bounding-box-based retrieval engine may analyze the image provided by the user or accessed in the item listing system to determine what objects or items within the image are products that need to be utilized in the generation of an embedding. Once the products are determined, either through interaction by a user or through analysis of the image such as with a machine learning model, the bounding-box-based retrieval engine may determine the location, size and shape of bounding boxes within the image based on the text data within the image. The text data may be determined or generated through known methods such as OCR.

The bounding-box-based retrieval engine may generate a polygonal shape that encompasses the text or symbol data and use the coordinates of this polygon to determine the bounding boxes. In embodiments, the bounding boxes may be determined based on assessing a number of coordinate points in the image that if connected would encompass the entirety of a set of text data. The bounding-box-based retrieval engine is configured to distinguish between groups of text and symbols and generate bounding for each set of text or symbols such that the bounding box coordinates can be utilized in the generation of embeddings.

Step 203B: generate image identifiers corresponding to the plurality of items, the image identifiers corresponding to the bounding box and the text data of the plurality of images.

In embodiments, the image identifiers may be generated based on embeddings for various pieces of data within the image. For example, the bounding box coordinates may be utilized to generate a vector representation of the bounding box data and that vector representation may be transformed into an embedding and utilized in the generation of the image identifier. The image identifier may be associated with a number of embeddings representing various aspects of the image data. For example, the image identifier may be generated utilizing only the bounding box data embedding and stored in a text-bounding box database.

In such embodiments, the image identifier generated from the bounding box data may be utilized to query other trading cards and determine a type of similar style of bounding box such that the item listing system can output more accurate results. Additionally, storing an image identifier comprised of only the bounding box data may save storage space and result in quicker response times from the item listing system. When the bounding box data is used in association with text or image data within the image identifier, the results may be even more accurate to the specific nature of trading cards or other products comprised of sets of text data.

204B: store the image identifiers in an index that is searchable to identify image identifiers based on a query.

The image identifier may be store in a text-bounding box database, an item listing database, or both. In embodiments, if the image identifier is stored within a text-bounding box database, the text-bounding box database may first be queried to find similar products based on the bounding box data. This may then be used when querying the entire item listing database. As such, the image identifier comprised of bounding box data may be used to narrow down the field of search such that quicker and more accurate results are retrieved. In additional or alternative embodiments, the image identifier may comprise image data, bounding box data, text data, and any other set of data that is helpful in organizing and querying items in an item listing database. This may all be store in the item listing database in association with a product identifier such that the bounding box data may be included in the assessment of most accurate query results.

205B: receive a query comprising an image of an item having text data.

When a user wishes to search the item listing systems for a product, they may provide an image of the product to the item listing system. The bounding-box-based retrieval engine may process the image included in the query in order to determine results most similar to a product included in the image. Similar to the process above, the bounding-box-based retrieval engine determines areas of the image that include a product and areas within the product that comprise sets of test of symbol data. This data may be extract such that included in the query is data representing the positioning size, and shape of the bounding boxes of the product. The bounding-box-based retrieval engine may also extract the text data for text included in the bounding boxes. As such, the system can use this information to generate an identifier that can be used to query the item listing system for similar products.

206B: generate a query image identifier for the item, the query image identifier corresponding to the bounding box and the text data of the image.

As discussed above, the image identifier may be associated with the bounding box data without being associated with the text data of the image. In embodiments where efficiency of storage and speed of query results are prominent, the image identifier does not need to be associated with the text data of the image. Also similar to that discussed above, the bounding-box-based image identifier, comprised of the bounding box data and not the text data, may be stored in a specific text-bounding box database that may be queried by the system to determine similar types of products which may limit the number of products that need to be queried in the item listing database.

That being said, the image identifier may include all relevant data of the image and product within the image, including the bounding box data such that the single image identifier comprises all information determined to be relevant to the product. These image identifiers may be utilized by the system to query an index comprised of other image identifiers.

207B: compare the query image identifier to the image identifiers corresponding to the plurality of image identifiers corresponding to the plurality of items to determine a query response item identifier that best matches the query image identifier.

The image identifier generated through the utilization of the bounding box data may be used to query an index of image identifiers. The index of image identifiers may include any number of image identifiers that are associated with other products having sets of text of symbol data and associated bounding boxes such that the bounding boxes of the product in the query image may be compared against the bounding boxes of the products listed in the index through comparing the image identifiers.

For example, a trading card having two small bounding boxes on the upper left and right corners may be compared against other trading cards. If the other trading cards do not have the same two small bounding boxes in the upper left and right corners, then the bounding-box-based retrieval engine would determine that they are not valid results for the query. The bounding boxes of the query image would be compared against all other products with bounding boxes and only products having similar bounding boxes would be returned.

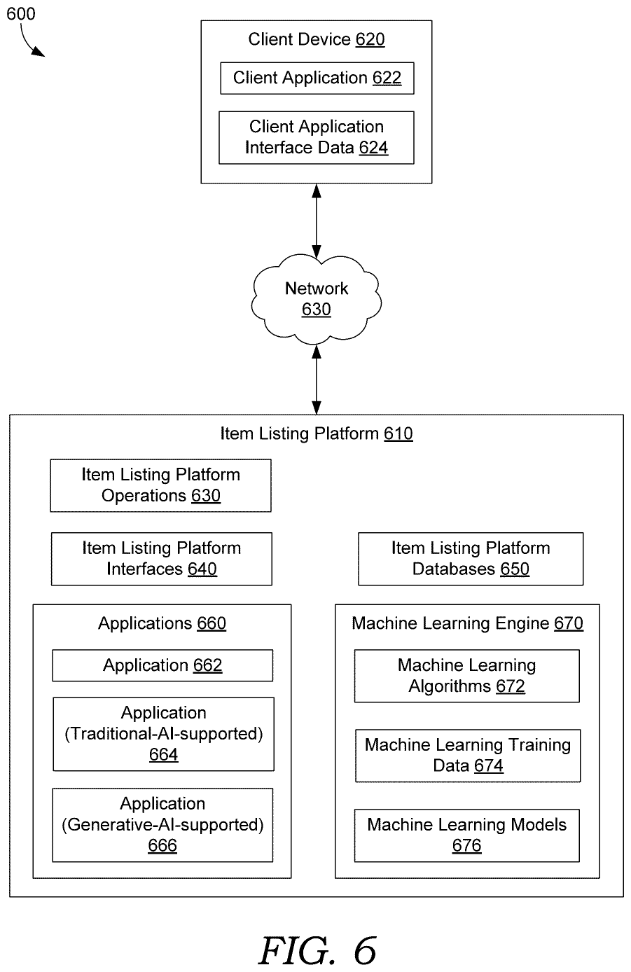

Aspects of the technical solution can be described by way of examples and with reference to FIGS. 1A, 1B, 2A, and 2B. FIG. 2A is a block diagram of an exemplary technical solution environment, based on example environments described with reference to FIGS. 6, 7, and 8 for use in implementing embodiments of the technical solution are shown. Generally the technical solution environment includes a technical solution system suitable for providing the example item listing system 600 in which methods of the present disclosure may be employed. In particular, FIG. 2A shows a high-level architecture of the image processing system 100 in accordance with implementations of the present disclosure. Among other engines, managers, generators, selectors, or components not shown (collectively referred to herein as “components”), the image processing system 100 of FIG. 2A support functionality described in FIGS. 1A and 1B.

### Example Methods

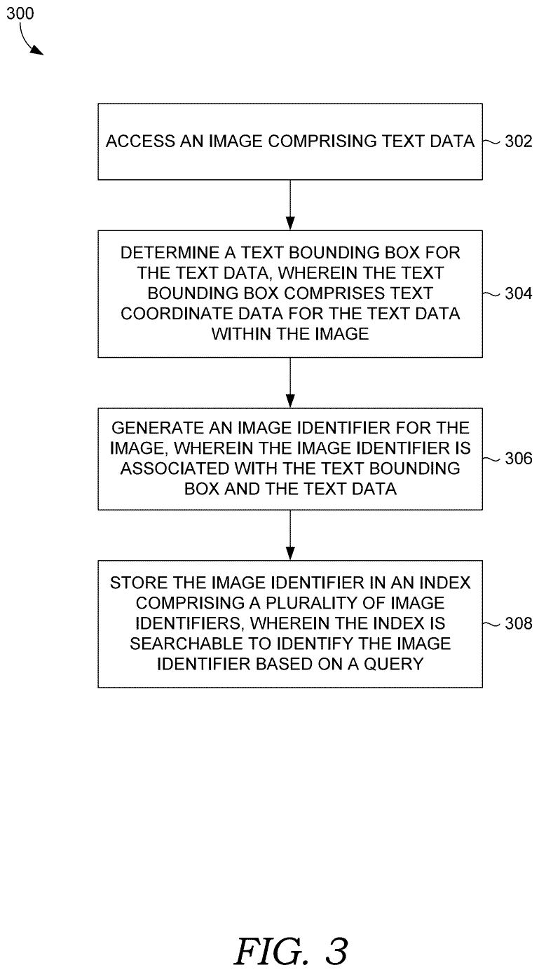

With reference to FIGS. 3, 4, and 5 flow diagrams that illustrate methods for generating and storing image identifiers based on determined text bounding boxes. The methods may be performed using the artificial intelligence and image processing system described herein. In embodiments, one or more computer-storage media having computer-executable or computer-useable instructions embodied thereon that, when executed, by one or more processors can cause the one or more processors to perform the methods (e.g., computer-implemented method) in an artificial intelligence system (e.g., computerized system or computer system).

Turning to FIG. 3, a flow diagram is provided that illustrates a method 300 for generating and storing image identifiers based on determined text bounding boxes. At block 302, access an image comprising text data. In embodiments, the image comprises a shape associated with a trading card. Determining the text bounding box may further comprise determining a location of the text data within the trading card. In additional or alternative embodiments, generating the image identifier for the image may be based on a size ratio between the trading card and the bounding box. This is also described herein as normalizing the bounding box to the image or product within the image. Generating the size ration may be based on determining a size of the trading card or product and comparing the size of the trading card or product to a size of the bounding box. At block 304, determine a text bounding box for the text data within the image. At step 306, generate an image identifier for the image, wherein the image identifier is associated with the text bounding box and the text data. The image identifier may be associated with the shape of the trading card. At step 308, store the image identifier in an index comprising a plurality of image identifiers, wherein the index is searchable to identify the image identifier based on a query. The index may be a k-Nearest Neighbor index. In embodiments, the method further comprises accessing a second image comprising a second text data, wherein the second image is associated with a query, determining a second text bounding box for the second text data, wherein the second text bounding box comprises a second text coordinate data for the second text data within the second image. The method may further comprise generating a second image identifier for the second image, wherein the second image identifier is associated with the second text bounding box and the second text data and comparing the second image identifier against the index comprising the plurality of image identifiers. Based in comparing the second image identifier against the index a third image identifier may be identified and the third image associated with the third image identifier may be communicated as a response to the query.

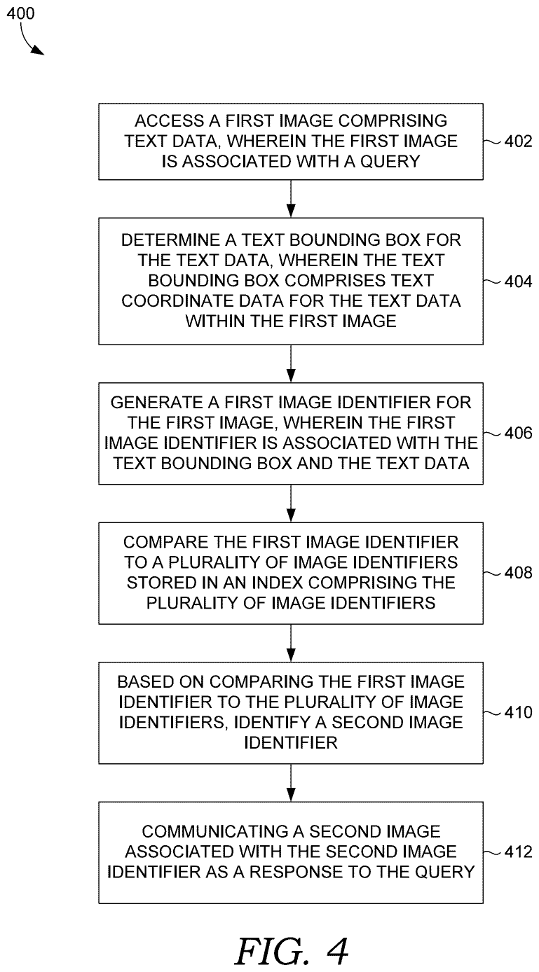

Turning to FIG. 4, a flow diagram is provided that illustrates a second method 400 for generating image identifiers based on determined text bounding boxes and identifying a second image identifier based on the generated image identifier. At block 402, access a first image comprising text data, wherein the first image is associated with a query. In embodiments, the first image may also comprise symbol data such as a shape, image, or design. At block 404, determine a text bounding box for the text data, wherein the text bounding box comprises text coordinate data for the text data within the first image. Determining the text bounding box for the text data comprises receiving a selection at a user interface selecting a first product of two products within the image, wherein the selecting the first product causes the text bounding box to be determined. At block 406, generate a first image identifier for the first image, wherein the first image identifier is associated with the text bounding box and the text data. At block 408, compare the first image identifier to a plurality of image identifiers stored in an index comprising the plurality of image identifiers. At block 410, based on comparing the first image identifier to the plurality of image identifiers, identify a second image identifier. Identifying the second image identifier may further comprise determining that the second image identifier substantially matches the first image identifier. At block 412, cause display of a second image associated with the second image identifier, wherein the second image is a response to the query. In embodiments, the method may comprise determining a symbol bounding box for the symbol data, wherein the symbol bounding box comprises symbol coordinate data for the symbol data within the first image, and generating the first image identifier for the first image, wherein the first image identifier is associated with the text bounding box, the text data, the symbol bounding box, and the symbol data. The method may further comprise comparing the first image identifier to a plurality of image identifiers stored in the index comprising the plurality of image identifiers, based on comparing the first image identifier to the plurality of image identifiers, identifying a second image identifier, and causing display of a second image associated with the second image identifier, wherein the second image is a response to the query. The plurality of image identifiers may be associated with a text bounding box, a text data, a symbol bounding box, and a symbol data.

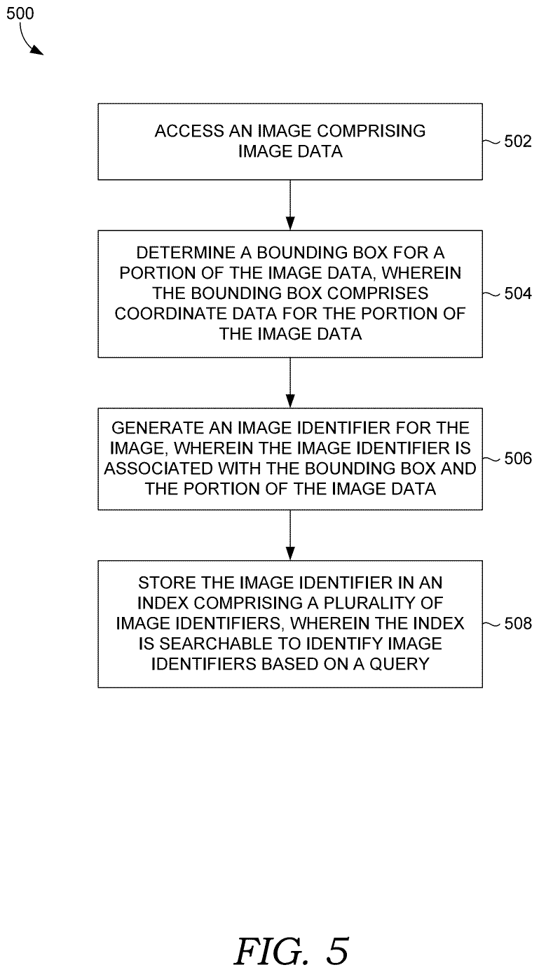

Turning to FIG. 5, a flow diagram is provided that illustrates a method 500 for generating and storing image identifiers based on determined bounding boxes. At block 502, access an image comprising image data. The image data may comprise a text data or a symbol data. The image may comprise a trading card, and the bounding boxes may be determined to be within the trading card. At block 504, determine a bounding box for a portion of the image data, wherein the bounding box comprises coordinate data for the portion of the image data. At block 506, generate an image identifier for the image, wherein the image identifier is associated with the bounding box and the portion of the image data. In embodiments, generating the image identifier for the image further comprises determining a size of the bounding box and a size of the trading card, utilizing the size of the bounding box and the size of the trading card, determining a size ratio, wherein the size ratio indicates a comparison between the size of the trading card and the size of the bounding box, and associating the size ratio with the image identifier. At block 508, store the image identifier in an index comprising a plurality of image identifiers, wherein the index is searchable to identify image identifiers based on a query. In embodiments, the method may further comprise accessing a second image comprising a second image data, determining a second bounding box for a portion of the second image data, wherein the second bounding box comprises a second coordinate data for the portion of the second image data within the second image, and generating a second image identifier for the second image, wherein the second image identifier is associated with the second bounding box and the portion of the second image data. In embodiments, the method further comprises comparing the second image identifier against the index comprising the plurality of image identifiers, based on comparing the second image identifier against the index, identifying a third image identifier, and causing display of a third image associated with the third image identifier.

### Technical Improvement

Embodiments of the present invention have been described with reference to several inventive features (e.g., operations, systems, engines, and components) associated with an item listing system. Inventive features described include: operations, interfaces, data structures, and arrangements of computing resources associated with providing the functionality described herein relative with reference to a bounding-box-based retrieval engine associated with an image processing system.

Embodiments of the present invention relate to the field of computing, and more particularly to an image processing system and item listing system. The following described exemplary embodiments provide a system, method, and program product to, among other things, process images to determine bounding boxes which are used in generating embeddings for storage within an index such that the index is searchable based on the embeddings generated utilizing the determined bounding boxes. Therefore, the present embodiments improve the technical field of image processing systems and item listing systems enhancing the efficiency and effectiveness of generating embeddings and querying databases such as those utilized by item listing systems. For example, the bounding-box-based retrieval engine generates bounding box data and transforms the bounding box data into embeddings which may be utilized in the storage and querying of a database such as that of an item listing system. When generating embeddings for certain types of products, such as trading cards, the location, size, and shape of bounding boxes can be particularly relevant.

As such, the bounding-box-based retrieval engine provides a particularly efficient search and storage system allowing for the utilization of bounding box data in the form of normalized coordinate data to generate embeddings which may be efficiently stored and search. This removes the need to store large quantities of data in association with some products. Or, even if the standard data is stored in association with products, the addition of the bounding box data may provide for more nuanced results that recognize the importance of the bounding boxes of certain products. This provides for an improvement to technology by creating an efficient embedding generation and storage system that may be queried for quicker and more accurate results.

Functionality of the embodiments of the present invention have further been described, by way of an implementation and anecdotal examples—to demonstrate that the operations for generating and storing embeddings based on determined bounding boxes in an image process system and item listing system as a solution to a specific problem in image processes, storage, and retrieval technologies to improve computing operations in image processing and item listing systems. Overall, these improvements result in less CPU computation, smaller memory requirements, and increased flexibility in image processing systems and item listing systems when compared to previous conventional image processing system and item listing system operations performed for similar functionality.

### ADDITIONAL SUPPORT FOR DETAILED DESCRIPTION OF THE INVENTION

Example Item Listing System Environment

Referring now to FIG. 6, FIG. 6 illustrates an example item listing system 600 computing environment in which implementations of the present disclosure may be employed. In particular, FIG. 6 shows a high-level architecture of an example item listing platform 610 that can host a technical solution environment, or a portion thereof. It should be understood that this and other arrangements described herein are set forth as examples. For example, as described above, many elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The item listing system 600 can be a cloud computing environment that provides computing resources for functionality associated with the item listing platform 610. For example, the item listing system 600 supports delivery of computing components and services—including servers, storage, databases, networking, applications, and machine learning associated with the item listing platform 610 and client device 620. A plurality of client devices (e.g., client device 620) include hardware or software that access resources on the item listing system 600. Client device 620 can include an application (e.g., client application 622) and interface data (e.g., client application interface data 624) that support client-side functionality associated with the item listing system. The plurality of client devices can access computing components of the item listing system 600 via a network (e.g., network 626) to perform computing operations.

The item listing platform 610 is responsible for providing a computing environment or architecture that includes the infrastructure that supports providing item listing platform functionality (e.g., e-commerce functionality). The item listing platform support storing item in item databases and providing a search system for receiving queries and identifying search results based on the queries. The item listing platform may also provide a computing environment with features for managing, selling, buying, and recommending different types of items. Item listing platform 610 can specifically be for a content platform such as EBAY content platform or e-commerce platform, developed by EBAY INC., of San Jose, California.

The item listing platform 610 can provide item listing operations 630 and item listing interfaces 640. The item listing operations 630 can include service operations, communication operations, resource management operations, security operations, and fault tolerance operations that support specific tasks or functions in the item listing platform 610. The item listing interfaces 640 can include service interfaces, communication interfaces, resource interfaces, security interfaces, and management and monitoring interfaces that support functionality between the item listing platform components. The item listing operations 630 and item listing interfaces 640 can enable communication, coordination and seamless functioning of the item listing system 600.

By way of example, functionality associated with item listing platform 610 can include shopping operations (e.g., product search and browsing, product selection and shopping cart, checkout and payment, and order tracking); user account operations (e.g., user registration and authentication, and user profiles); seller and product management operations (e.g., seller registration and product listing and inventory management); payment and financial operations (e.g., payment processing, refunds and returns); order fulfillment operations (e.g., order processing and fulfillment and inventory management); customer support and communication interfaces (e.g., customer support chat/email and notifications); security and privacy interfaces (e.g., authentication and authorization, payment security); recommendation and personalization interfaces (e.g., product recommendations and customer reviews and ratings); analytics and report interfaces (e.g., sales and inventory reports, and user behavior analytics); and APIs and Integration Interfaces (e.g., APIs for Third-Party Integration).

The item listing platform 610 can provide item listing platform databases (e.g., item listing platform databases 650) to manage and store different types of data efficiently. The item listing platform databases 650 can include relational databases, NoSQL databases, search databases, cache databases, content management systems, analytics databases, payment gateway database, customer relationship management databases, log and error databases, inventory and supply chain databases, and multi-channel databases that are used in combination to efficiently manage data and provide e-commerce experience for users.

The item listing platform 610 supports applications (e.g., applications 660) that is a computer program or software component or service that serves a specific function or set of functions to fulfil a particular item listing platform requirement or user requirement. Applications can be client-side (user-facing) and server-side (backend). Applications can also include application without any AI support (e.g., application 662) application supported by traditional AI model (e.g., application 664), and applications supported by generative AI models (e.g., application 666). By way of example, applications can include an online storefront application, mobile shopping app, admin and management console, payment gateway integration, user account and authentication application, search and recommendation engines, inventory and stock management application, order processing and fulfillment application, customer support and communication tools, content management system, analytics and report applications, marketing and promotion applications, multi-channel integration applications, log and error tracking applications, customer relationship management (CRM) applications, security applications, and APIs and web services that are used in combination to efficiently deliver e-commerce experiences for users.

The items listing platform 610 can include a machine learning engine (e.g., machine learning engine 670). The machine learning engine 670 refers to machine learning framework or machine learning platform that provides the infrastructure and tools to design, train, evaluate, and deploy machine learning models. The machine learning engine 670 can serve as the backbone for developing and deploying machine learning applications and solutions. Machine learning engine 670 can also provide tools for visualizing data and model results, as well as interpreting model decisions to gain insights into how the model is making predictions.

The machine learning engine 670 can provide the necessary libraries, algorithms, and utilities to perform various tasks within the machine learning workflow. The machine learning workflow can include data processing, model selection, model training, model evaluation, hyperparameter tuning, scalability, model deployment, inference, integration, customization, data visualization. Machine learning engine 670 can include pre-trained models for various tasks, simplifying the development process. In this way, the machine learning engine 670 can streamline the entire machine learning process, from data preparation and model training to deployment and inference, making it accessible and efficient for different types of users (e.g., customers, data scientists, machine learning engineers, and developers) working on a wide range of machine learning applications.

Machine learning engine 670 can be implemented in the item listing system 600 as a component that leverages machine learning algorithms and techniques (e.g., machine learning algorithms 672) to enhance various aspects of the secure vault engine functionality. Machine learning engine 670 can provide a selection of machine learning algorithms and techniques used to teach computers to learn from data and make predictions or decisions without being explicitly programmed. These techniques are widely used in various applications across different industries, and can include the following examples: supervised learning (e.g., linear regression: classification, support vector machines (SVM); unsupervised learning (e.g., clustering, principal component analysis (PCA), association rules (e.g., apriori); reinforcement learning (e.g., Q-Learning, deep Q-Network (DQN); and deep learning (e.g., neural networks, convolutional neural networks (CNN), and recurrent neural networks (RNN); and ensemble learning random forest.

Machine learning training data 674 supports the process of building, training, and fine-tuning machine learning models. Machine learning training data 674 consists of a labeled dataset that is used to teach a machine learning model to recognize patterns, make predictions, or perform specific tasks. Training data typically comprises two main components: input feature (X) and labels or target values (Y). Input features can include variables, attributes, or characteristics used as input to the machine learning model. Input features (X) can be numeric, categorical, or even textual, depending on the nature of the problem. For example, in a model for predicting house prices, input features might include the number of bedrooms, square footage, neighborhood, and so on. Labels or target values (Y) include the values that the model aims to predict or classify. Labels represent the desired output or the ground truth for each corresponding set of input features. For instance, in a spam email classifier, the labels would indicate whether each email is spam or not (i.e., binary classification). The training process involves presenting the model with the training data, and the model learns to make predictions or decisions by identifying patterns and relationships between the input features (X) and the target values (Y). A machine learning algorithm adjusts its internal parameters during training in order to minimize the difference between its predictions and the actual labels in the training data. Machine learning engine 670 can use historical and real-time data to train models and make predictions, continually improving performance and user experience.

Machine learning engine 670 can include machine learning models (e.g., machine learning models 676) generated using the machine learning engine workflow. Machine learning models 676 can include generative AI models and traditional AI models that can both be employed in the item listing system 600. Generative AI models are designed to generate new data, often in the form of text, images, or other media, based on patterns and knowledge learned from existing data. Generative AI models can be employed in various ways including content generation, product image generation, personalized product recommendations, natural language chatbots, and content summarization. Traditional AI models encompass a wide range of algorithms and techniques and can be employed in various ways including recommendation systems, predictive analytics, search algorithms, fraud detection, customer segmentation, image classification, Natural Language Processing (NLP) and A/B testing and optimization. In many cases, a combination of both generative and traditional AI models can be employed to provide a well-rounded and effective e-commerce experience, combining data-driven insights and creativity.

Machine learning engine 670 can be used to analyze data, make predictions, and automate processes to provide a more personalized and efficient shopping experience for users. By way of example, product recommendations search and filtering: pricing optimization, inventory and stock management: customer segmentation, churn prediction and retention, fraud detection, sentiment analysis, customer support and chatbots, image and video analysis, and ad targeting and marketing. The specific applications of machine learning within the item listing platform 610 can vary depending on the specific goals, available data, and resources.

### Example Distributed Computing System Environment

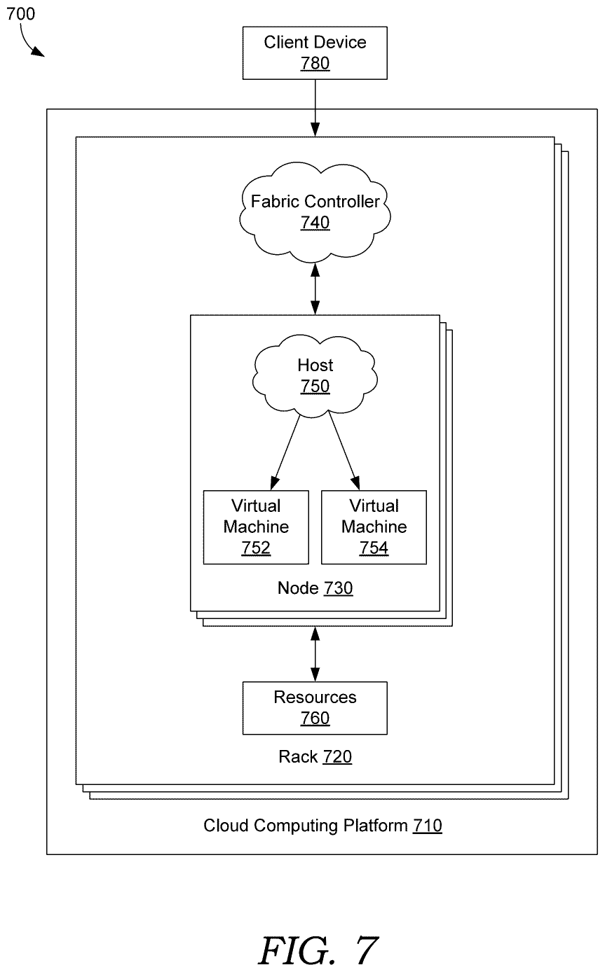

Referring now to FIG. 7, FIG. 7 illustrates an example distributed computing environment 700 in which implementations of the present disclosure may be employed. In particular, FIG. 7 shows a high-level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing platform 710 in a data center can be configured to host and support operation of endpoints of a particular service application. Cloud computing platform 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 800 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

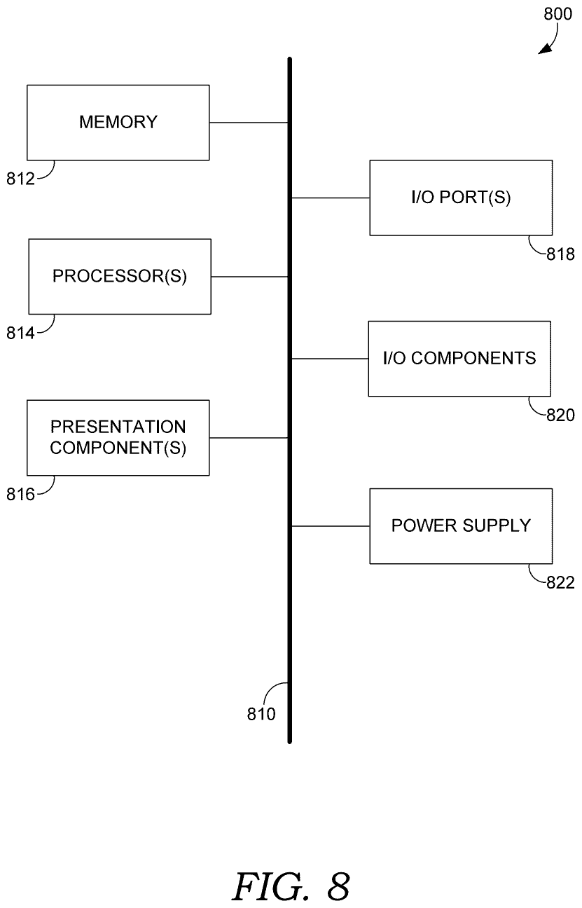

Having briefly described an overview of embodiments of the present invention, an example operating environment in which embodiments of the present invention may be implemented is described below in order to provide a general context for various aspects of the present invention. Referring initially to FIG. 8 in particular, an example operating environment for implementing embodiments of the present invention is shown and designated generally as computing device 800. Computing device 800 is but one example of a suitable computing environment and is not intended to suggest any limitation as to the scope of use or functionality of the invention. Neither should computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art and reiterate that the diagram of FIG. 8 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious, and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing an image comprising text data;
determining a text bounding box for the text data, wherein the text bounding box comprises text coordinate data for the text data within the image;
based on determining the text bounding box for the text data, generating an image identifier for the image, wherein the image identifier is associated with the text bounding box and the text data; and
storing the image identifier in an index comprising a plurality of image identifiers, wherein the index is searchable to identify the image identifier based on a query associated with a query text bounding box for query text data.

2. The system of claim 1, the operations comprising:
accessing an image comprising text data;
determining a text bounding box for the text data;
accessing a second image comprising a second text data, wherein the second image is associated with a query;
determining a second text bounding box for the second text data, wherein the second text bounding box comprises a second text coordinate data for the second text data within the second image;
generating a second image identifier for the second image, wherein the second image identifier is associated with the second text bounding box and the second text data;
comparing the second image identifier against the index comprising the plurality of image identifiers;
based on comparing the second image identifier against the index, identifying a third image identifier; and
communicating a third image associated with the third image identifier, wherein the third image is a response to the query.

3. The system of claim 1, wherein the image further comprises a shape associated with a trading card.

4. The system of claim 3, wherein determining the text bounding box further comprises determining a location of the text data within the trading card.

5. The system of claim 3, wherein generating the image identifier for the image is based on a size ratio between the trading card and the text bounding box.

6. The system of claim 5, wherein generating the size ratio is based on:
determining a size of the trading card; and
comparing the size of the trading card to a size of the text bounding box.

7. The system of claim 3, wherein the image identifier is further associated with the shape of the trading card.

8. The system of claim 1, wherein the index is a k-Nearest Neighbor index.

9. A computer-implemented method, the computer-implemented method comprising:
accessing a first image comprising text data, wherein the first image is associated with a query;
determining a text bounding box for the text data, wherein the text bounding box comprises text coordinate data for the text data within the first image;
based on determining the text bounding box for the text data, generating a first image identifier for the first image, wherein the first image identifier is associated with the text bounding box and the text data;
comparing the first image identifier to a plurality of image identifiers stored in an index comprising the plurality of image identifiers, wherein the index is searchable based on the query;
based on comparing the first image identifier to the plurality of image identifiers, identifying a second image identifier; and
communicating the second image identifier to cause display of a second image associated with the second image identifier, wherein the second image is a response to the query.

10. The computer-implemented method of claim 9, wherein the first image further comprises a symbol data.

11. The computer-implemented method of claim 10, wherein the computer-implemented method further comprises:
determining a symbol bounding box for the symbol data, wherein the symbol bounding box comprises symbol coordinate data for the symbol data within the first image;
generating the first image identifier for the first image, wherein the first image identifier is associated with the text bounding box, the text data, the symbol bounding box, and the symbol data;
comparing the first image identifier to the plurality of image identifiers stored in the index comprising the plurality of image identifiers;
based on comparing the first image identifier to the plurality of image identifiers, identifying the second image identifier; and
causing display of the second image associated with the second image identifier, wherein the second image is the response to the query.

12. The computer-implemented method of claim 11, wherein the plurality of image identifiers are associated with a text bounding box, a corresponding text data, a corresponding symbol bounding box, and a corresponding symbol data.

13. The computer-implemented method of claim 9, wherein determining the text bounding box for the text data further comprises receiving a selection at a user interface selecting a first product of a plurality of products within the first image, wherein selecting the first product causes the text bounding box to be determined.

14. The computer-implemented method of claim 9, wherein identifying the second image identifier further comprises determining that the second image identifier substantially matches the first image identifier.

15. One or more computer-storage media having computer-executable instructions embodied thereon that, when executed by a computing system having a processor and memory, cause the processor to perform operations, the operations comprising:
accessing an image comprising image data;
determining a bounding box for a portion of the image data, wherein the bounding box comprises coordinate data for the portion of the image data;
based on determining the bounding box, generating an image identifier for the image, wherein the image identifier is associated with the bounding box and the portion of the image data; and
storing the image identifier in an index comprising a plurality of image identifiers, wherein the index is searchable to identify image identifiers based on a query associated with a query text bounding box for query text data.

16. The media of claim 15, wherein the operations further comprise:
accessing a second image comprising a second image data;
determining a second bounding box for a portion of the second image data, wherein the second bounding box comprises a second coordinate data for the portion of the second image data within the second image;
generating a second image identifier for the second image, wherein the second image identifier is associated with the second bounding box and the portion of the second image data;
comparing the second image identifier against the index comprising the plurality of image identifiers;
based on comparing the second image identifier against the index, identifying a third image identifier; and
causing display of a third image associated with the third image identifier.

17. The media of claim 15, wherein the image data comprises a text data or a symbol data.

18. The media of claim 15, wherein the image further comprises a trading card.

19. The media of claim 18, wherein the bounding box is determined to be within the trading card.

20. The media of claim 19, wherein generating the image identifier for the image further comprises:
determining a size of the bounding box and a size of the trading card;
utilizing the size of the bounding box and the size of the trading card, determining a size ratio, wherein the size ratio indicates a comparison between the size of the trading card and the size of the bounding box; and
associating the size ratio with the image identifier.
